(19) United States
(12) Patent Application Publication
(10) Pub. No.: US 2002/0061100 A1
(43) Pub. Date: May 23, 2002

(54) Virtual telephony

(76) Inventors: Carmen A. DiCamillo, Churchville, PA (US); Kenneth M. Giannantonio, Medford, NJ (US); Brian S. Adelson, Willow Grove, PA (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/737,137

(22) Filed: Dec. 14, 2000

Related U.S. Application Data
(60) Provisional application No. 60/223,389, filed on Aug. 7, 2000.

(51) Int. Cl. H04M 7/00

(52) U.S. Cl. 379/221.02; 379/219; 379/222

(57) ABSTRACT

A method of and system for telecommunication are disclosed, in which a service provider establishes a point of presence with a plurality of telephone numbers in at least one first vicinity. The service provider receives telephone calls to those numbers and relays each such call over a wide-area network (WAN) to a recipient in a second vicinity to which the telephone number in question is not local. Each said telephone number is assigned to a specific recipient, and each call is directed to its recipient on the basis of the telephone number to which it was made, so that each number can be presented to potential callers as if it were a local number in the first vicinity for the recipient, even though the recipient may have no physical presence in the first vicinity. The recipient thus has a “Virtual Telephone Number” (VTN) in the first vicinity. The caller need merely telephone the local number in his or her own vicinity, and is connected to the recipient without any further action or effort on the caller's part.

### CROSS-REFERENCE TO RELATED APPLICATIONS

This application is related to U.S. application Ser. No. 60/223,389, filed Jul. 7,2000, and entitled “Virtual Telephony,” the entire contents of which are herein incorporated by reference.

### FIELD OF THE INVENTION

The invention relates to the transmission of telephone calls, and especially to a method and system for enabling people to communicate by voice over long distances by making only a local telephone call, and without needing to input anything except an ordinary local telephone number in order to be connected to the distant recipient.

### BACKGROUND OF THE INVENTION

In today's business environment, with marketing on a national basis becoming the norm even for small businesses, the following scenario is commonplace.

A company is located in one city (the “host” city), for example, Philadelphia, and has a local Philadelphia telephone number. For sales and marketing purposes, the company wishes to give its clientele and potential clientele the impression that it has a presence in another city (the “foreign” city), for example, San Francisco. However, it is not practical for the company to establish an office in San Francisco. The company therefore desires to have a local San Francisco telephone number that, when dialed by callers in the San Francisco region, has from the caller's point of view all of the characteristics of connecting locally in San Francisco, but in reality rings the company's office in Philadelphia. A conventional toll-free number would not be satisfactory, because it does not specifically associate the company with San Francisco.

As another example, consider a business located in suburban New York. While the business may be located outside the New York City Local Calling Area, the city may represent a majority of its clientele. Ideally, the business would obtain local telephone service in New York City but have the calls terminate at its suburban location.

In addition to businesses, private individuals may also have reasons to route calls over a long distance. Often times, family members move to other cities for various reasons such as job or college. A locally available number would be an ideal solution to encourage a distant family member to telephone frequently without incurring the cost of long distance charges or the inconvenience of a collect call. For example, a parent from Chicago who retires and moves to Miami, or a child from Chicago who goes to college in Miami, could dial a local Miami number, incurring only a Miami local call charge, to talk to family members in Chicago. Likewise, those same family members in Chicago could dial a local number in Chicago to speak with their parent or child in Miami.

Conventional telephony attempts to address the aforementioned scenarios in several ways, all of which are wasteful of resources and/or prohibitively expensive. One method for establishing a presence is to obtain local telephone lines in each city where a presence is desired. This can only be accomplished by leasing real estate in the city in which a number is desired, thereby establishing an actual presence. Once this physical presence is acquired, a local telephone line can be purchased from the Local Exchange Carrier (LEC). A call forwarding option on the number can then be purchased to allow someone to dial the local number and have the host city personnel answer the phone. Whenever a call comes in on these numbers, all associated long distance charges are paid by the host. Add these charges to the monthly recurring fees for the number, the call forwarding plan, and the cost of real estate, and this model quickly becomes cost prohibitive, especially for a company that desires a presence in two or more cities.

Another shortcoming to this approach is the fact that someone usually has to be physically present on the line in each local city to activate the forwarding options. Call forwarding is intended by the LECs as a short-term function, for use when a telephone line is temporarily unattended. Consequently, the forwarding data is stored at the LEC Central Office (CO) in comparatively volatile storage, which may easily become erased or corrupted. Should forwarding fail for any reason, someone would have to visit the local site to reactivate forwarding.

An alternative to call forwarding would be to establish a telephone number in the remote city and have that number used as a Foreign Exchange (FX) line to the host city. FX lines exist within the LEC Central Office in the foreign city, which eliminates the need for leasing real estate in the city of choice. In order to FX the number to the host city, however, a dedicated line must be installed from the foreign city CO to the host city CO. That line, capable of carrying one telephone call at a time, is not subject to long distance charges in the traditional sense. Instead, the line is charged on a per mile basis. An FX line crossing Local Access and Transport Areas consists of three basic parts. The serving Central Office at each end of the FX line must have facilities dedicated to that line. This portion of the line is called a “tail.” Each tail is run from the serving CO to an Inter Exchange Carrier (IXC). It is the IXC that allows the FX line to cross Local Access and Transport Area (LATA) boundaries. All three portions involve mileage charges. The FX line, like the aforementioned local telephone line, requires dedicated facilities in each central office. Since the line is charged on a per mile basis, the further away the host city is from the foreign city, the more expensive the line becomes. If it is desired to be able to answer more than one simultaneous phone call from a particular city, a number of FX lines, determined by the number of simultaneous phone calls to be answered, must be leased. Each of these lines carries with it the mileage charge. A presence in more than one city might need several lines running from each remote location to the host location. Because dedicated lines are used, which under normal conditions will be idle for most of the time, this system is very inefficient in the use of resources.

For most businesses, these scenarios can quickly become cost prohibitive, requiring staff and monthly fees far outweighing the amount of revenue that the apparent presence in the foreign city can generate. For the individual, and small businesses, the above scenarios are not even an option.

Brief description of the invention The present invention provides a method and system by which a caller in one city can dial a local number in that city, while the call is routed to and answered in a distant host city, without the above-described disadvantages of conventional techniques. The city where the caller is located is referred to as a “foreign” city. A foreign city is any city that is in a different Local Access and Transport Area from the “host” city, where the recipient of the call is located. It does not need to be in a different state or country.

One aspect of the invention provides a method of and system for telecommunication, in which a service provider establishes a point of presence with a plurality of telephone numbers in at least one first vicinity. The service provider receives telephone calls to those numbers and relays each such call over a wide-area network (WAN) to a recipient in a second vicinity to which the telephone numbers are not local. Each said telephone number is assigned to a specific recipient, and can be presented to potential callers as if it were a local number for the recipient in the first vicinity, even though the recipient has no physical presence in the first vicinity. The recipient thus has a “Virtual Telephone Number” (VTN) in the first vicinity.

According to another aspect of the invention, the service provider procures a stock of telephone numbers, served by the LEC, in each “foreign” city where the VTN service is to be available. A customer desiring this service then needs only to select the city or cities where it wants to have a local presence (in the first example above, San Francisco). The customer is then presented with a list of available VTN numbers for each city selected. In each case, the available numbers are a Local Call within the cities selected, just as if an actual physical presence was established in that particular area. The customer selects one or more VTNs in each of the cities desired. The customer then specifies the actual destination telephone number to which calls to the VTNs will be directed. In most instances this will be the customer's actual Local Telephone number in the host city. In the first example above, that would be the Philadelphia number. The setup procedure may be conducted by the potential customer on the service provider's web page. Once the VTN setup has been completed, the customer is able to begin receiving calls from the San Francisco area on its existing telephone lines in Philadelphia as if those lines were actually located in San Francisco (a Virtual San Francisco Telephone Number). The calling party is provided with a Local number to call in San Francisco while the customer answers the call in Philadelphia. By advertising its new San Francisco number, the customer establishes its “Virtual Presence” in San Francisco.

With the creation of the “Virtual Telephone Number”, the service provider is able to provide both businesses and individuals the ability to purchase Local Telephone Service without the restrictions and problems inherent in the conventional approaches discussed above. There is no need for real estate to be leased and the presence is truly “virtual.” Utilizing Voice Over Internet Protocol (VoIP), the service provider is able to carry the call from one city to another on a WAN, thereby eliminating the need for dedicated facilities and eliminating high Long Distance charges. VoIP on a WAN allows far more efficient use of available transmission capacity than conventional telephony, because in VoIP only the actual speech is transmitted. Conventional telephony maintains a continuous two-way circuit for the entire duration of the telephone call, and in any normal telephone call that circuit is carrying only silence for a surprisingly high proportion of the time. In addition, under present regulations in the U.S., a VoIP service provider is exempt from the per-minute access charge that the foreign city LEC would normally impose on a long-distance carrier, and may also avoid the per-minute termination charge imposed by the host city LEC. Since the service provider allows the individual or business to purchase service on a city-by-city basis, a customer can tailor its presence to specific target markets.

The VTN is also extremely convenient for the caller, who need only dial a local telephone number in his or her own area. The service provider's local gateway automatically recognizes the number dialed, and the service provider then identifies the host number, establishes the necessary connections, and routes the call through to the host customer, all without any further action by the caller. The caller need never know that he or she has made anything other than a simple local telephone call. Even if the caller does know that he or she is connecting to a distant host, he or she still has all the same convenience and simplicity as if he or she were making only a local call.

In operation, when a caller in San Francisco dials the San Francisco number, the gateway begins processing by looking for the Philadelphia number the call is to be redirected to. Once that number is established, the information is routed to the destination gateway (in this case to Philadelphia) via TCP/IP. The destination gateway then places its own Local call to the Philadelphia number. Voice over IP technology takes the sound of the caller's voice, typically received by the gateway in the form of a data stream on a digital telephone line, and encapsulates it into data packets. These packets then get routed over the service provider's intranet using TCP/IP.

The entire process requires no additional equipment, no leased lines, and no call forwarding on the customer business's part. In addition, since it is the service provider supplying the actual local calling lines, the consumer need not purchase multi-line hunt capability in the foreign city to allow more than one simultaneous call.

In this model, the fact that facilities can be shared makes this application even more cost effective. The service provider supplies the multiple line connection capability to the LEC Central Office in both the host and remote cities. The service provider also supplies the talk path over existing IP network topology, and the telephone numbers.

This whole model can also be supplied to the private consumer market as well. The model is cost effective enough to allow individuals in one city to purchase their own number in a remote city through the service provider. This example would apply to someone with family members living in the remote city. By giving the family members a local number to dial, the model is more cost effective than current collect call rates.

### BRIEF DESCRIPTION OF THE DRAWINGS

FIG. 1 is a block diagram of a first form of Virtual Telephone number system.

FIG. 2 is a block diagram, corresponding to part of FIG. 1, of a second form of Virtual Telephone number system.

FIG. 3 is a block diagram of a customer registration system associated with the Virtual Telephone number system of FIG. 1.

### DETAILED DESCRIPTION OF THE DRAWINGS

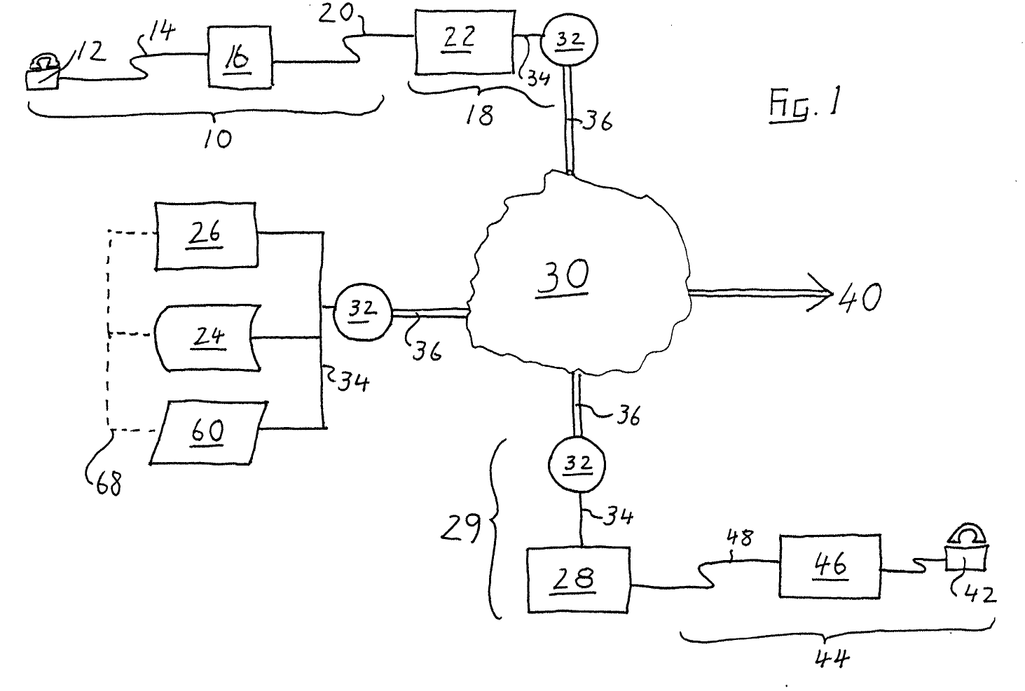

Referring to FIG. 1, in a first form of Virtual Telephone Number (VTN) system, the recipient in the “host” city does not have a dedicated connection to the VTN service provider. All of the equipment that is utilized for this connection exists on the intranet of the Service Provider. Calls are completed by the service provider's Point of Presence equipment in the host city placing a conventional local telephone call to the recipient.

When a caller in a “foreign” city, for example, San Francisco, wishes to telephone the recipient company, the first part of the call uses the conventional Public Switched Telephone Network (PSTN) local call system 10. The caller uses a telephone 12, which is connected over a local loop 14 to the Local Exchange Carrier (LEC) Central Office 16. The local loop may be a conventional analog line using a pair of copper wires, or may be whatever alternative the particular LEC happens to use. The caller dials the Virtual Telephone Number of the host-city recipient. That number is an ordinary local telephone number in the foreign city (for example, San Francisco). The switching equipment in the LEC Central Office (CO) 16 connects the call to the dialed number in the ordinary way. However, in this case, the number is at the VTN service provider's Point of Presence 18 in San Francisco.

Because the VTN service provider receives a large volume of calls to a large block of numbers at a single physical location, the telephone line 20 from the CO 16 to the service provider's gateway 22 is preferably, but not necessarily limited to, a high-capacity digital link. A block of numbers is assigned to the service provider by the LEC that provides the PSTN service. Because it is unlikely that every one of the Virtual Telephone Numbers will be called simultaneously, the physical capacity of the digital line 20 and the gateway 22 can be less than the number of telephone numbers, provided that the calls are sent from the Central Office 16 in a form that includes the number being dialed. Most simply, the gateway 22 appears to the Central Office 16 switching equipment as if it were a Private Automatic Branch Exchange with Direct Inward Dialing.

A Virtual Telephone number can at present be terminated at the gateway 22 with a variety of different types of connections from the PSTN. These types of connection are usually determined by how the circuit is encoded. Two types of encoding in general use are Primary Rate ISDN (PRI) and T1 CAS (Channel Associated Signaling).

One form of PRI interface consists of twenty-three Bearer channels and one Data channel. By using this type of connection, all of the signaling information can be sent directly to the gateway through a separate channel, and a 64 kb/s data stream can be utilized for each call. Thus, although in the interests of simplicity only a single call will be described, the digital line 20 and the gateway 22 will in practice be capable of handling a number of calls simultaneously.

One mechanism that the PRI line uses to present data to the gateway is known as Q.931 messaging. The general format of a Q.931 message includes a single byte protocol discriminator, a call reference value to distinguish between different calls being managed over the same Data channel, a message type, and various information elements (IEs). When a call is initiated to the PRI line from the PSTN, a SETUP message is generated, which can contain the following IEs:

Sending complete, Repeat indicator, Bearer capability, Channel identification, Progress indicator, Network specific facilities, Display, Keypad facility, Signal, Calling party number, Calling party sub address, Called party number, Called party sub address, Transit network selection, Repeat indicator, Low layer compatibility, High layer compatibility. The Bearer Capability specifies a requested service: packet or circuit mode, data rate, and type of information content. This information allows the gateway to determine what type of call is being presented along the Data channel. The gateway stores the information that is sent in the Q.931 message and uses the information to determine where the call is to be routed. After the information is received from the Data channel, a Bearer channel is allocated to handle the incoming call, and a Call Proceeding message is sent back to the Data channel to indicate that the unit is ready to handle the call. At the same time as the Call Proceeding message is sent back, the gateway starts to process the DNIS so that the call can be properly connected to the correct destination gateway.

The processing of the DNIS is done first by the local gateway 22, which retrieves the information in a central database 24 maintained by the service provider. The central database 24 keeps all information regarding any incoming Virtual Telephone number. Database 24 servers maybe located at diverse locations through the service provider's intranet, if the benefit of easier access to the data is judged to outweigh the burden of keeping the different copies of the database consistent. If there is more than one available database 24 server, the gateway 22 will determine which is closest and send traffic there first. There are several steps introduced when the gateway 22 sends a request to the database 24 server. The gateway provides an information request to the server, which includes but is not limited to the DNIS, ANI and port location of the call or any other information deemed appropriate for the type of service being offered.

As in the case of a simple telephone call, the DNIS information that is provided by the PSTN Central Office 16 to the gateway 22 is the Virtual Telephone Number that was dialed by the caller. It corresponds to the intended recipient of the call, and enables the call to be routed to the correct destination. In normal operation, the service provider will have some unused numbers available. If a call is received to one of those numbers, it is presumed to be a “wrong number” and the call is rejected as invalid. The ANI information identifies the caller. Where the VTN is a virtual presence of a company, the ANI information is usually only of informational value at this stage. However, a private VTN may be configured so as to accept calls only from certain specified numbers. For example, where a VTN is set up to allow family members to call one another, it may accept calls only from the home number of one of the family members in question. It would also be possible to configure a VTN to reject calls from particular numbers. The port location at the gateway 22 enables the reply from the database server 24 to be matched to the correct telephone call.

Once the database 24 server has received the information request from the gateway 22, it checks to see if any relevant information exists. If the proper information was presented by the gateway 22, and a Virtual Telephone Number exists, then the database 24 server sends back an acknowledge (ACK) request to the gateway 22. When the ACK request is sent to the gateway 22, the call can proceed for remote termination at the host location. If the database server does not recognize any of the information that is sent in the initial request, a acknowledge reject (NAK) message is sent back to gateway. If the gateway 22 receives a NAK request, then the gateway will notify the caller of the status of the Virtual Telephone number and terminate the call.

When the ACK is sent from the database server 24, the gateway 22 sends an Alerting message back on the Data channel to inform the PSTN Central Office 16 that it is ready to accept the call. At this time, the gateway 22 contacts the gatekeeper 26 to set up the Voice over IP (VoIP) leg of the call.

The VoIP leg is initiated when the Q.931 message sends an initialization request to the gateway 22. This request is then forwarded to the gatekeeper 26 as an encapsulated message. While several protocols exist to transmit inforational packets necessary for call completion, the following scenario deacribes the utilization of the H.323 subset H. 225 protocol. The H.225 message initially sent contains an Alert message that stores various pieces of information about the incoming call. The gatekeeper 26 sends back an H.225 message informing the gateway 22 of the correct destination gateway 28 at the correct destination Point of Presence 29 to which the call is to be sent. The gatekeeper 26 may access a central database 24 for calls that will be terminated in the VoIP network, and/or direct each gateway 22 on how to handle each incoming call. One benefit of using the gatekeeper 26, rather than allowing each gateway 22 independently to route calls solely on the basis of information from the database 24, is that the gatekeeper 26 may query each gateway 22 for network problems and resource utilization so that each call can be completed on the first attempt. Once the gatekeeper 26 has returned the information specifying which destination gateway 28 is to be utilized, subsequent H.225 messages are sent to the gatekeeper 26 to help keep track of all resources that are used for the call.

Once the originating gateway 22 has obtained all the necessary information from the gatekeeper (i.e., resource utilization, and the proper gateway 28 to terminate the call), the originating gateway 22 contacts the destination gateway 28 over the service provider's intranet 30, via appropriate routers 32, and initiates a data connection for the VoIP call. The originating gateway 22 converts speech received from the PSTN into IP (Internet Protocol) packets. The VoIP call may be carried by Ethernet lines 34 between each gateway 22, 28, by a router 32 local to that gateway, by high-speed data links 36 from one router 32 to the next over the intranet 30, or by any combination thereof.

Continuing with the present example, the originating gateway 22 initiates the call by sending a Setup message to the terminating gateway 28. When the Setup message is received, the terminating gateway 28 will send back an Alerting and Connect message to indicate that it is ready for the call to be placed. The call signaling is followed by a capability exchange of messages, and each gateway 22, 28 sends a termCapSet message to communicate its media settings to the other gateway 28, 22. The media settings that are sent also inform each gateway of the different codecs that are available to handle the call at the other gateway. Once the media information has been exchanged between the two gateways, each gateway sends a termCapSetAck message to acknowledge the other gateway's termCapSet message. Next a master and slave gateway are determined by the masterSlvDet and masterSlvDetAck messages. The master/slave setup is necessary to avoid any conflicts in situations such as the opening of a bi-directional channel for communication. The originating gateway 22 opens a logical channel by sending an openReq message. Once this is received by the terminating gateway 28, it creates a logical channel in the opposite direction. A benefit of this type of setup is that each gateway has the ability to open as many channels as necessary for the call.

At this point, a connection is made between the two gateways 22, 28. The network equipment allocated at each Point of Presence (POP) 18, 29 provides the audio connection. Call transmission is established when the gateway 22 sends IP traffic through the Ethernet connection 34 to the router 32. When the router 32 receives the traffic, it will prioritize all information that is VoIP related and sent it to the intranet 30. All of the routers 32 at the POPs 18, 29 are connected using the high-speed data links 36 so that packet loss and jitter do not occur during the call.

In the interests of simplicity, only one originating POP 18 and one destination POP 29 are shown in detail in FIG. 1. However, there will typically be a large number of POPs connected to the intranet 30, indicated symbolically in FIG. 1 by the arrow 40, and each POP will usually be capable of acting both as an originating POP 18 and as a destination POP 29. The high-speed data links 36 thus interconnect each POP to multiple other locations on the intranet 30.

Once the gateways 22, 28 have established a VoIP leg for the call, the terminating gateway 28 then initiates an outbound call over the local PSTN 44 to the host telephone 42. The outbound call leg is sent from the terminating gateway 28 to the PSTN Central Office 46, so all of the information is resent to the CO 46. The CO then connects the call to the host telephone 42 as if it were an ordinary local call within the destination area.

When the call is delivered to the host telephone 42, there are several functions that are performed after the ring is sent to the destination location. Caller-ID (CLID) is presented to the recipient. Depending on the system used by the destination PSTN, the CLID may merely indicate a call from the service provider's host city POP 29, or may carry information supplied by the service provider indicating the true origin of the call. It may also be possible to send a distinctive ring from the destination POP 29 to the host telephone 42, or to send a distinctive ringing tone from the origination POP 18 to the caller's telephone 12. When the recipient answers the phone 42, the destination gateway 28 can announce to the recipient the original location from which the call was dialed.

For the duration of the call, the gateways 22,28 keep a data channel open between them, so that traffic can pass back and forth. As explained above, in order to reduce the volume of traffic, data packets are sent only when there is actual speech to be transmitted. Silences in the telephone conversation are represented by the absence of data packets. When one of the locations 12, 42 terminates the call, the corresponding gateway 22, 28 sends a closeReq message so that the call teardown process can begin. Once the teardown process is completed, all resources are freed and the gatekeeper 26 receives notification of new resources available.

The second example of encoding that may be used for the Virtual Telephone number would be if the originating Central Office 16 was connected to the originating POP 18 by a T1 line. There are several different types of T1 lines that can be delivered into the gateway 22, but all have the same underlying function. The main requirement would be a T1 that sends DNIS information over to the gateway 22. The typical call flow for this type of connection would be as follows. Once a call is sent from the PSTN 10 to the gateway 22, only seven bits are used for the data layer of the call. The last bit is used to send the call control information (known as bit robbed signaling). The transmit ABCD bits go off hook in order to send a signal to the gateway 22 that an incoming call is to be sent. At this time the gateway 22 will send back to the CO 16 the corresponding bits to acknowledge the incoming call. After both sides have acknowledged the presence of the call, the DNIS information is sent over the carrier line using the “8^{th} bit.” Once the gateway 22 receives the call, it follows the same steps as a PRI line for handling the incoming call. Once the DNIS is sent to the gateway 22, the corresponding Bearer channel is allocated for the duration of the call. Once the information is obtained from the T1 line, the call is routed through the gatekeeper 26 and gateways 22, 28 in the same fashion as described in the previous example.

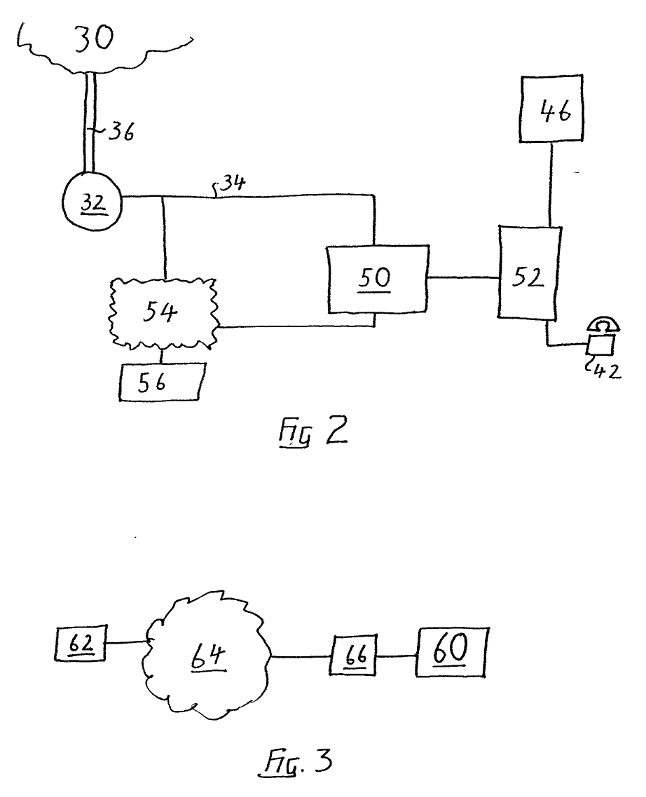

Referring now to FIG. 2 as well as FIG. 1, not all calls directed through the network 30, 32, 36 need be terminated back out to the destination PSTN 44. Instead, a call to a Virtual Telephone Number can be terminated on a recipient's equipment, known as a local gateway 50. The local gateway 50 is physically connected to the high-speed links 36 of the service provider's intranet 30 by an Ethernet line 34 and a router 32 in the same way as the service provider's own gateways 22, 28 shown in FIG. 1. The local gateway 50 connects to the gatekeeper 26 and registers its telephone number when it is online. Once the registration has taken place, the originating gateway 22 will send a request to the gatekeeper 26 to determine resources and identify the terminating gateway 50 as described previously. When a call is received by the local gateway 50, instead of being forwarded to a PSTN Central Office 46 it is connected directly to the recipient's switchboard or Private Branch Exchange (PBX) 52, from which it is connected to the telephone 42. The PBX 52 is also connected to the PSTN Central Office 46 in the usual way. PBXs capable of handling incoming calls from both private and public incoming lines are widely available.

There are many different types of equipment that can be connected to the gateway 50 for the recipient. There are many different ways in which the local gateway 50 can be connected to the VoIP intranet 30. One way would be to have a Digital Subscriber Line (DSL).

If the service provider's intranet 30 is not dedicated exclusively to VoIP, then a recipient having a local gateway 50 may also receive and/or send non-voice traffic, which may be directed, either at the router 32 that connects the local gateway 50 to the high-speed data links 36 or after passing through the gateway 50, to other equipment, such as the recipient's local area network (LAN) 54. VoIP traffic may also be routed to the LAN 54, if there is equipment 56 on the LAN that is capable of handling VoIP traffic.

If two separate customer sites are connected to the service provider's WAN by local gateways 50, then voice or data traffic can be sent from one site to another over the WAN without using public carriers. This provides a “Virtual Private Network” connecting the two sites.

For added security, under either scheme the VoIP packets may be sent from the originating gateway 22 to the destination gateway 29, 50 in encrypted form.

Referring now to FIGS. 1 and 3, the service provider provides an electronic interface that allows for creation, addition, deletion, and general modifications of the virtual telephone number service. It is through this interface that the customer creates his, her or its virtual presence in a remote city. One method is to use a web interface for management.

Utilizing the aforementioned scenario, the customer only needs to open a web browser 62 connected to the world wide web 64 and go to the appropriate web page 66 on the service provider's web site. At this page 66, the customer has the option to select what city they would like their virtual telephone number to exist in. Once they have made this selection, they are presented with a list of available telephone numbers. These numbers are pulled from the central database 24, which has a full listing of all direct inward dialing numbers obtained from the LEC, by the electronic interface 60. The electronic interface 60 is preferably connected to a database server supporting a copy of the central database 24, and to the gatekeeper 26, by a LAN 68. Instead, they may be physically separate and may communicate over the intranet 30.

When the VTN has been selected, the customer is then requested to provide the host telephone numbers at the host location. If the customer is not already a user of the VTN service, these numbers may be validated, to ensure that there is a POP 29 within the local call distance of the host location. Once the selection of VTN and host telephone numbers has been made, more options are presented to the customer. These options can encompass times of day at which the VTN system should or should not attempt to connect a call, how to handle the call if the host locations are busy/no answer, or if a message is to be played based upon a specific calling number.

After the customer has made all of the available selections on the interface 60, the information is stored in the central database 24. After the information is stored, a request is sent out to all of the corresponding gateways 22, 28 and gatekeepers 26 providing them with the necessary changes. The gateways and gatekeepers can incorporate these changes within 20 minutes of the update, thus providing the customer with flexibility that is currently not available in the conventional telephony market.

If the customer wishes to use a local gateway 50, the physical connection may take more than 20 minutes to arrange. However, such a customer can be provided with a temporary service via the host-city PSTN 44 until the local gateway connection is established.

Although the present invention has been described and illustrated with respect to exemplary embodiments thereof, it should be understood by those skilled in the art that various changes, omissions, and additions may be made therein and thereto, without departing from the spirit and scope of the invention as defined in the attached claims. In particular, although call handling using an incoming T1 or PRI line and using TCP/IP and Ethernet has been described in detail, because those systems are commonly found in practice, it will be understood that the choice of particular standards is not essential, and that the present invention may be practiced using other forms of telephone line and network protocol that exist, or that may be introduced in the future. It will also be understood that where, for example, T1 and PRI lines to the LEC Central Offices are used, different LECs may use different protocols, and each gateway will support the protocol used by its own LEC.

Although the invention has been described in terms of using the system to transmit voice telephone calls, it will be understood that fax transmissions, and anything else that is at present transmitted over telephone lines, can be handled in the same way.

Although the invention has been described using the service provider's own Wide Area intranet, the invention could be carried out using the publicly accessible internet. However, the large and variable volume of other traffic on the internet, and the lack of control over transmission, tend to result in practice in packets becoming lost or materially delayed. As a result, internet VoIP tends to have markedly poorer sound quality than can be obtained using an intranet that is entirely under the control of a single service provider, and on which VoIP traffic can be guaranteed priority.

What is claimed is:

1. A method of telecommunication comprising:
providing a point of presence in at least one first vicinity with a plurality of telephone numbers;
receiving telephone calls to those numbers; and relaying the telephone calls via a wide area network to recipients in at least one second vicinity to which said telephone numbers are not local;
wherein each said telephone number is assigned to a specific recipient, and each call is directed to its recipient on the basis of the telephone number to which it was made.

2. A method according to claim 1, wherein said relaying step comprises transmitting said calls to a telephone system within a recipient organization.

3. A method according to claim 1, wherein said relaying step comprises routing said calls from said wide area network to a local area network within a recipient organization.

4. A method according to claim 1, wherein said relaying step comprises making a local telephone call to said recipient from a second point of presence local to said recipient, and relaying a received call over said wide area network to said second point of presence and in the form of said local telephone call from said second point of presence to said recipient.

5. A method according to claim 1, further comprising procuring telephone numbers in said first vicinity and then making such numbers available to potential recipients i n at least one other vicinity.

6. A method according to claim 5, which comprises procuring telephone numbers in a plurality of first vicinities, and making such numbers available to potential recipients in a plurality of vicinities.

7. A telecommunications system comprising:
a point of presence comprising a first gateway to which a plurality of telephone numbers are assigned connected to a telephone central office by telephone circuitry and connected to a wide area network; and
a database associating at least some of said telephone numbers with respective destinations on the wide area network;
wherein said gateway is arranged to receive incoming calls to said plurality of telephone numbers from said telephone circuitry in a manner that identifies to said gateway the telephone number among said plurality of telephone numbers to which each incoming call was directed;
and wherein said gateway is arranged to route such calls to respective said destinations determined on the basis of the telephone numbers among said plurality of telephone numbers to which such calls are made.

8. A telecommunications system according to claim 7, wherein information identifying the telephone numbers among said plurality of telephone numbers to which such calls are made is the only information about such calls that is used in routing such calls.

9. A telecommunications system according to claim 7, further comprising a second gateway connected to a telephone central office by telephone circuitry and connected to said wide area network;
wherein said first gateway is arranged to route to said second gateway calls made to at least some said telephone numbers; and
wherein said second gateway is arranged, in response to a first telephone call received by said first gateway and routed to said second gateway, to make a second telephone call to a telephone number local to said second gateway and determined by the telephone number at said first gateway to which said call was made.

10. A telecommunications system according to claim 7, further comprising:
a second gateway; and
a telephone system connected to said second gateway;
wherein said first gateway is arranged to route to said second gateway calls made to at least some said telephone numbers;
wherein said second gateway is arranged, in response to a first telephone call received by said first gateway and routed to said second gateway, to route said telephone call to said telephone system; and
wherein said telephone system is arranged to connect said call to a telephone instrument.

11. A telecommunications system according to claim 7, further comprising:
a second gateway;
a local area network connected to said second gateway; and
an apparatus connected to said local area network and capable of transmitting and receiving speech over said networks;
wherein said first gateway is arranged to route to said second gateway calls made to at least one said telephone number;
wherein said second gateway is arranged, in response to a first telephone call received by said first gateway and routed to said second gateway, to route said telephone call to said local area network; and
wherein said local area network is arranged to connect said call to said apparatus capable of transmitting and receiving speech.

12. A telecommunications system comprising:
at least one first gateway connected to a telephone central office by telephone circuitry to which a plurality of telephone numbers are assigned and connected to a wide area network; and
at least one second gateway connected to a telephone central office by telephone circuitry and connected to a wide area network;
said at least one first gateway being arranged to receive telephone calls to said numbers on said telephone circuitry and to establish communication over said wide area network with said at least one second gateway;
said at least one second gateway being arranged, in response to a first telephone call received by said first gateway, to make a second telephone call to a telephone number local to said second gateway and determined by the telephone number at which said at least one first gateway receives a call; and
said first and second gateways being arranged to connect said first call to said second call in such a manner that the originator of said first call and the recipient of said second call are able to communicate as if said originator had telephoned said recipient directly.

13. A telecommunications system according to claim 12, comprising a plurality of said first gateways and a plurality of said second gateways, and wherein each first gateway is arranged, in response to receiving a first telephone call, to communicate only with a selected one of said plurality of second gateways local to said recipient.

14. A telecommunications system according to claim 12, further comprising a wide area network connecting said first and second gateways.

15. A telecommunications system comprising:
at least one first gateway connected to a telephone central office by telephone circuitry to which a plurality of telephone numbers are assigned and connected to a wide area network; and
at least one second gateway connected to the wide area network and to a telephone system of a recipient organization;
said at least one first gateway being arranged to receive telephone calls to said numbers on said telephone circuitry and to establish communication over said wide area network with said at least one second gateway;
said at least one second gateway being arranged, in response to a first telephone call received by said first gateway, to establish a telephone connection into said recipient organization; and
said first and second gateways being arranged to connect said first call to said telephone connection in such a manner that the originator of said first call and the recipient of said telephone connection are able to communicate as if said originator had telephoned said recipient directly.

16. A telecommunications system according to claim 15, comprising a plurality of said second gateways connected to different recipient organizations, and wherein said at least one first gateway is arranged, in response to receiving a first telephone call, to communicate only with a selected one of said plurality of second gateways determined by the telephone number to which said first call was made.

17. A telecommunications system according to claim 15, further comprising a wide area network connecting said first and second gateways.
